(19) United States
(12) Patent Application Publication
(10) Pub. No.: US 2008/0218468 A1
(43) Pub. Date: Sep. 11, 2008

(54) METHOD AND APPARATUS FOR CONTROLLING POWER OF DISPLAY DEVICE BASED ON HISTOGRAM OF INPUT IMAGE AND DISPLAY DEVICE INCLUDING THE APPARATUS

(75) Inventors: Sung-hee Kim, Seoul (KR); Young-jin Kwon, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/833,265

(22) Filed: Aug. 3, 2007

(30) Foreign Application Priority Data
Mar. 5, 2007 (KR) 10-2007-0021600

(51) Int. Cl. G09G 3/36

(52) U.S. Cl. 345/102

(57) ABSTRACT

A method and an apparatus for controlling a power of a display device including a backlight, and a display device having a power controlling function are provided. The apparatus includes: a histogram analyzer that analyzes a histogram of an input image signal including one or more color components, and determines an intensity clipping based on the analyzed histogram; an image brightness compensation unit that calculates an intensity increasing ratio of the input image signal using the intensity clipping, and applies the intensity increasing ratio to each of the color components to generate an output image signal, an intensity of which is increased; and a backlight brightness controller that controls a brightness of the backlight based on the intensity increasing ratio.

### CROSS-REFERENCE TO RELATED PATENT APPLICATION

This application claims priority from Korean Patent Application No. 10-2007-0021600, filed on Mar. 5, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to a display device, and more particularly, to reducing a power consumption of the display device while minimizing a brightness degradation of an output image signal that is displayed by complementarily controlling a brightness of the output image signal and a brightness of a backlight, based on a brightness distribution of an input image signal.

2. Description of the Related Art

As electronic technology has developed, the performance of consumer electronics is being rapidly improved. In particular, the development of high-end and large display devices in recent years has been astonishing.

Flat panel display devices such as liquid crystal displays (LCDs) and plasma display panels (PDPs) lead the development of the high-end display devices. While sizes of the flat panel display devices are increasing, prices of the flat panel display devices are being reduced. Therefore, lower priced large flat panel display devices have become popular in a home display device market, and this tendency is likely to continue.

As the size of the display devices increases, image software for full high-definition (HD) level resolution in addition to standard definition (SD) and HD level image signals can be fabricated. This will be accelerated when storage media having high storage capacities such as HD-digital versatile discs (DVDs) and BluRay discs, as well as DVDs, are used. In addition, improvements to audio equipment have been made, as well as the display devices, and recently, 5.1-channel sound can be appreciated using a wireless home theater using a local area network, such as Bluetooth. Therefore, general consumers can enjoy high quality images with high quality sound using a large screen at their home.

However, due to the enlargement of the display devices, power consumption of the display devices has also increased. In addition, as the display devices become larger, the power consumption increases, and thus, this may cause a serious problem. In particular, in order to conform with a progressive stage system, in which electric charge applied to a unit power consumption amount increases when the power consumption increases, various technologies for reducing the power consumption of the display device have been introduced.

For example, a related art display device can operate at a maximum power saving mode and a minimum power saving mode. In the maximum/minimum power saving modes, a brightness of a backlight is set to a predetermined level regardless of input image signals. Here, the brightness to be reduced is determined according to the power saving mode selected.

However, in the power saving method of the related art, a predetermined brightness reducing value that is selected by a user is applied to all input image signals. Therefore, the entirety of an output image becomes dark, and in particular, distortion due to loss of brightness of the image signal in a bright scene may occur.

Therefore, a technology for reducing the power consumption of the display device without affecting the brightness of the output image signal is required.

### SUMMARY OF THE INVENTION

The present invention provides a method of controlling power consumption of a display device, which increases a brightness of an image signal based on a histogram of an input image signal and reduces a brightness of a backlight in proportion with the increase of the brightness of the image signal, so that a user cannot recognize a loss of brightness.

The present invention also provides a color compensation apparatus that can prevent a color of an output image signal from being degraded when a brightness of the output image signal is increased, based on a histogram of an input image signal.

The present invention also provides a display device that can reduce power consumption by complementarily controlling a brightness of an output image signal and a brightness of a backlight based on a histogram of an input image signal.

According to an aspect of the present invention, there is provided an apparatus for controlling a power of a display device including a backlight, the apparatus including: a histogram analyzer that analyzes a histogram of an input image signal including one or more color components, and determines an intensity clipping based on the analyzed histogram; an image brightness compensation unit that calculates an intensity increasing ratio of the input image signal using the intensity clipping, and applies the intensity increasing ratio to each of the color components to generate an output image signal, an intensity of which is increased; and a backlight brightness controller that controls a brightness of the backlight based on the intensity increasing ratio.

The apparatus may further include: a color compensation unit that detects saturated color components among the color components of the input image signal, and applies a color compensation ratio that is smaller than the intensity increasing ratio to the saturated color components to generate the output image signal. The color compensation unit may determine a maximum intensity increasing ratio and a minimum intensity increasing ratio of each of the saturated color components, and apply a color compensation weighed value to each of the maximum intensity increasing ratio and the minimum intensity increasing ratio to determine the color compensation ratio. The color compensation unit may calculate a quantization noise by modeling differences between the input image signal and the saturated color components, determine an error transfer function corresponding to the quantization noise, and apply the error transfer function to the input image signal to generate the output image signal.

According to another aspect of the present invention, there is provided a method of controlling a power of display device including a backlight, the method including: analyzing a histogram of an input image signal including one or more color components, and determining an intensity clipping based on the analyzed histogram; compensating an image brightness by calculating an intensity increasing ratio of the input image signal using the intensity clipping, and applying the intensity increasing ratio to each of the color components to generate an output image signal, an intensity of which is increased; and controlling a brightness of the backlight based on the intensity increasing ratio.

The method may further include: compensating colors by detecting saturated color components among the color components of the input image signal, and applying a color compensation ratio that is smaller than the intensity increasing ratio to the saturated color components to generate the output image signal. The compensating the colors may include: determining a maximum intensity increasing ratio and a minimum intensity increasing ratio of each of the saturated color components; and applying a color compensation weighed value to each of the maximum intensity increasing ratio and the minimum intensity increasing ratio to determine the color compensation ratio. The compensating the colors may include: calculating a quantization noise by modeling differences between the input image signal and the saturated color components; determining an error transfer function corresponding to the quantization noise; and applying the error transfer function to the input image signal to generate the output image signal.

According to another aspect of the present invention, there is provided a display device including a backlight including: an input image receiver that receives an input image signal including one or more color components; a histogram analyzer that analyzes a histogram of the input image signal, and determines an intensity clipping based on the analyzed histogram; an image brightness compensation unit that calculates an intensity increasing ratio of the input image signal using the intensity clipping, and applies the intensity increasing ratio to each of the color components to generate an output image signal, an intensity of which is increased; a backlight brightness controller that controls a brightness of the backlight based on the intensity increasing ratio; and a display unit that displays the output image signal.

The histogram analyzer may sum probability distribution functions of the input image signal from a maximum gradation of the input image signal to a predetermined gradation, determine a gradation value where a summed result is greater than or equal to a predetermined value, and set the gradation value as the intensity clipping. The histogram analyzer may multiply a difference between a maximum gradation and a predetermined gradation with probability distribution functions of the input image signal from the maximum gradation to the predetermined gradation, determine a gradation value where a multiplied result is greater than or equal to a predetermined value, and set the gradation value as the intensity clipping.

The image brightness compensation unit may generate the output image signal using at least one intensity increasing ratio, and the intensity increasing ratio may be reduced if the brightness of the input image signal increases.

The display device may further include: a look-up table that maps backlight brightness controlling values corresponding to the intensity clipping, and the backlight brightness controller may control at least one of an electric current and a voltage applied to the backlight based on the backlight brightness controlling values.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a power control apparatus of a display device according to an exemplary embodiment of the present invention;

FIG. 2 is a graph illustrating a process of determining an intensity clipping of an output of a histogram analyzer of FIG. 1;

FIGS. 3A and 3B are graphs illustrating operations of an image brightness compensation unit of FIG. 1;

FIGS. 4A through 4C are diagrams illustrating operations of a color compensation unit of FIG. 1;

FIGS. 5A through 5D are graphs showing examples of quantizing noises calculated by the color compensation unit of FIGS. 4A to 4C;

FIG. 6 is a flowchart illustrating a method of controlling a power consumption of a display device according to another exemplary embodiment of the present invention;

FIGS. 7A and 7B are graphs respectively showing brightness distribution of an input and output image signals according to an exemplary embodiment of the present invention; and

FIG. 8 is a block diagram showing a display device having a power consumption controlling function according to another exemplary embodiment of the present invention.

### DETAILED DESCRIPTION OF THE INVENTION

Hereinafter, the present invention will now be described more fully with reference to the accompanying drawings, in which exemplary embodiments of the invention are shown. Like reference numerals in the drawings denote like elements.

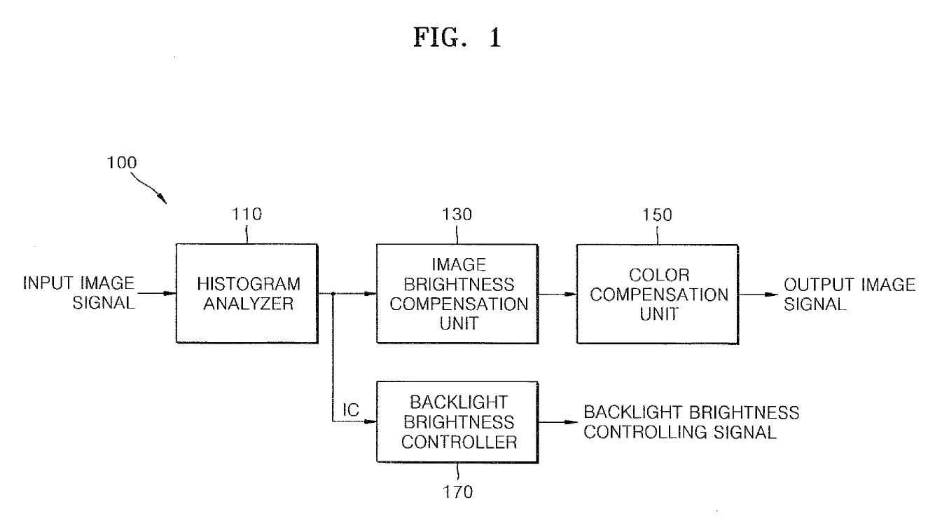

FIG. 1 is a block diagram of a power controlling apparatus of a display device according to an exemplary embodiment of the present invention. Referring to FIG. 1, a power controlling apparatus 100 includes a histogram analyzer 110, an image brightness compensation unit 130, a color compensation unit 150, and a backlight brightness controller 170.

When an input image signal is received, the histogram analyzer 110 calculates a brightness distribution of the input image signal and determines an intensity clipping (IC) using the calculated brightness distribution. When the IC is determined, the image brightness compensation unit 130 calculates an intensity increasing ratio using the determined IC, and applies the calculation result to each of color components in the input image signal.

The color compensation unit 150 readjusts a gradation of color components of an image signal that have become saturated due to the application of the intensity increasing ratio. In addition, the backlight brightness controller 170 controls a brightness of a backlight by generating a backlight brightness controlling signal using the IC. When the power controlling apparatus 100 of FIG. 1 is used, power consumption of the display device can be reduced, while a user of the display device hardly recognizes the change of brightness. This is because the image brightness compensation unit 130 increases the brightness of the input image signal corresponding while the backlight brightness controller 170 reduces the brightness of the backlight in consideration of the brightness distribution of the input image signal to reduce the power consumption. Hereinafter, each of the components of the power controlling apparatus 100 will be described in more detail as follows.

The histogram analyzer 110 determines the IC using the brightness distribution of the input image signal. The IC is determined by an accumulated histogram of pixels or an accumulated distortion value of the pixels. The accumulated distortion value can be calculated by the following Equation 1.

Accumulated distortion value=Sum(i−i′) (1)

In Equation 1, i denotes a brightness of each of the pixels in the input image signal, and i′ denotes a brightness of the pixel, as a result of applying the brightness increase of the image signal and the brightness reduction of the backlight to pixel i. As shown in Equation 1, the IC can be determined as a value that makes the accumulated distortion value a predetermined value. In this case, the IC represents a distortion amount of the brightness that is reduced by the user for reducing the power consumption.

Otherwise, the IC can be determined as a brightness including a probability distribution function of the uppermost 1% brightness of the entire brightness of the input image signal. In this case, the IC can be up to a maximum brightness amount that is determined to be lost by the user.

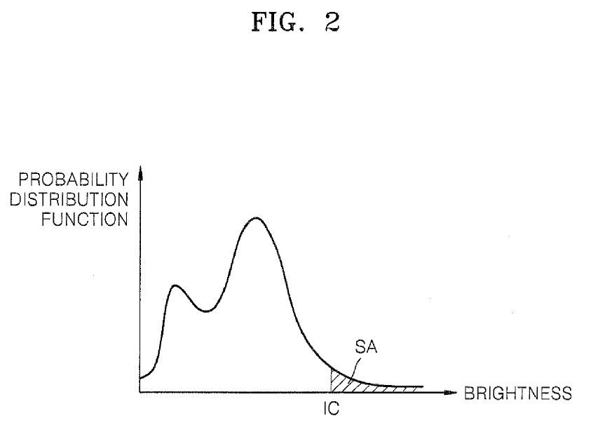

FIG. 2 is a graph illustrating a process of determining an intensity clipping of an output of the histogram analyzer 110 of FIG. 1. Referring to FIG. 2, the IC can be determined as the brightness distribution value of an area SA in the entire probability distribution function. If the area SA is 1% of the total area under the graph, it means that 1% of the input image signal has a brightness higher than the IC.

Otherwise, the IC can be calculated as a weighed sum that is weighed in consideration of an error of the histogram.

When the IC is determined, the image brightness compensation unit 130 receives the IC from the histogram analyzer 110, and calculates the intensity increasing ratio using the received IC. In addition, the image brightness compensation unit 130 applies the calculated intensity increasing ratio to each of the color components of the input image signal to generate an output image signal, the gradation of which is increased with respect to the input image signal. The intensity increasing ratio can be calculated by the following Equation 2.

Intensity increasing ratio=Imax/IC (2)

In Equation 2, Imax represents a maximum gradation of the image signal, and IC represents the intensity clipping. For example, when the maximum gradation is 255 and the IC is 200, the intensity increasing ratio is 255/200=1.275.

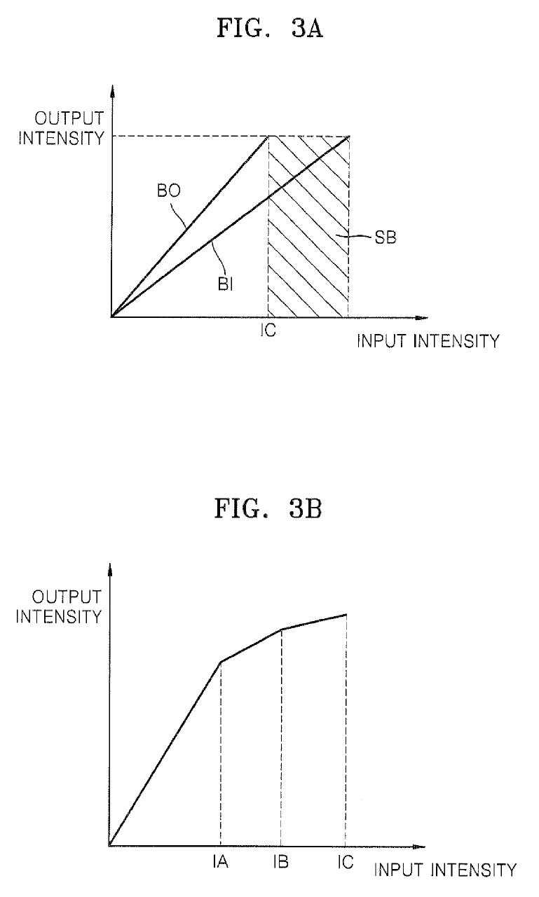

As shown in Equation 2, the intensity increasing ratio is a ratio of the maximum gradation of the input image signal to the IC. When the intensity increasing ratio is applied to the color components of the input image signal, the brightnesses of the color components increase. This process is shown in FIG. 3A.

FIGS. 3A and 3B illustrate operations of the image brightness compensation unit 130 of FIG. 1. Referring to FIG. 3A, the brightness BI of the input image signal increases by a predetermined ratio according to the intensity increasing ratio to generate the brightness BO of the output image signal. Therefore, according to the relation between the brightnesses of the input image signal and the output image signal of FIG. 3A, the brightnesses of a region SB of the input image signal all having brightnesses higher than the IC are all saturated to the highest brightness.

Referring to FIG. 3B which shows a relation between the brightnesses of the input image signal and the output image signal, unlike the graph of FIG. 3A, a constant intensity increasing ratio is not applied to the input image signal. Therefore, as shown in FIG. 3B, an intensity increasing ratio that is linearly changed at points IA and IB can be applied to the input image signal. When using the intensity increasing ratio of FIG. 3B, the size of a region in which all brightnesses are saturated in the output image signal can be greatly reduced. That is, if the input image signal shows bright clouds, regions around the clouds are changed to show white color in a case where the constant intensity increasing ratio is applied, and thus, the clouds cannot be distinguished from the adjacent regions. In this case, a low intensity increasing ratio can be applied to the section having the high brightness in the input image signal, and then, the degradation of the color components due to the brightness increase can be minimized.

Color components of the output image signal are compensated by the color compensation unit 150. For the convenience of explanation, it is assumed that the input image signal consists of red (R), green (G), and blue (B) color components, the gradation of the input image signal is (210, 250, 210) which is a light green color, and the intensity increasing ratio is 1.275. However, it will be appreciated by those skilled in the art that this is merely an example and the present invention is not limited thereto.

When the intensity increasing ratio is applied to the input image signal, the gradation of the input image signal becomes (268, 319, 268). However, since the maximum gradation is 255, the gradation of (268, 319, 268) is saturated into the gradation of (255, 255, 255), which is a white color. Therefore, as a result of applying the intensity increasing ratio to the input image signal, the original color of the input image signal is greatly distorted.

In order to prevent the above problem, the intensity increasing ratio between the input image signal and the output image signal is calculated for each color component, and the color components of the output image signal can be readjusted using the calculation result to correct the color components of the output image signal.

That is, in case of the color components R and B, the gradation 210 is increased to 255, and thus, the increasing ratio is 1.21. In addition, in case of the color component G, the gradation of 250 is increased to 255, and thus, the increasing ratio is 1.02. Then, a new increasing ratio can be obtained using the maximum increasing ratio 1.21 and the minimum increasing ratio 1.02. The new increasing ratio can be calculated by the following Equation 3, using an average of the maximum increasing ratio and the minimum increasing ratio, to which weighed values are applied respectively.

Compensated increasing ratio=(A×Max+B×Min)/(A+B) (3)

Here, Max and Min represent the maximum and minimum increasing rates of each color component, and A and B are real numbers. If A is greater than B, the brightness of the color component is increased, however, the probability of distorting the color is also increased due to the saturation of the color. If B is greater than A, the probability of distorting the color component is reduced, however, the brightness of the compensated color component is reduced. Therefore, weighed values A and B can be determined by the user. It is assumed that the compensated increasing ratio 1.07 is determined as a result of the calculation according to Equation 3. Then, the final output image signal has the gradation of (225, 255, 225), which maintains the light green color. The same intensity increasing ratio is applied to each of the color components of the input image signal because the increasing ratio of each of color components must be the same to reduce the color distortion. However, the present invention is not limited thereto, and the color components can be compensated using quantizing noise.

That is, a difference between the input image signal and the output image signal, the brightness of which is increased, is modeled using the quantizing noise, and then, an accuracy of compensating the color components can be improved.

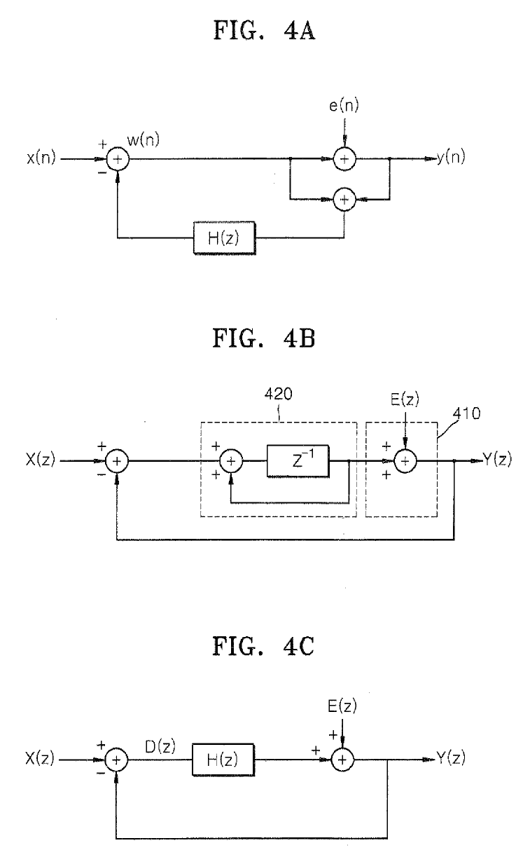

FIGS. 4A through 4C are diagrams illustrating operations of the color compensation unit 150 of FIG. 1. A one-dimensional quantization noise error transferring function can be obtained using the quantization noise modeling method as shown in FIGS. 4A to 4C as follows. In FIG. 4A, x(n) represents the input image signal, y(n) represents the output image signal, and e(n) is an error component. The following Equation 4 can be obtained from the block diagram of FIG. 4A.

y(n)=w(n)+e(n)

e(n)=y(n)−w(n) (4)

The following Equation 5 can be obtained in consideration of the quantization noise error system that is obtained by Z-transforming the block diagram of FIG. 4A.

Y(z)=W(z)+E(z)

W(z)=X(z)−H(z)E(z) (5)

The following Equation 6 can be obtained by representing Y(z) using X(z) and E(z) of Equation 5.

$$\begin{matrix}Y ( z ) = X ( z ) - H ( z ) E ( z ) + E ( z ) \\ = X ( z ) + [ 1 - H ( z ) ] E ( z ) \\ = X ( z ) + {H}_{e} ( z ) E ( z )\end{matrix} \qquad ( 6 )$$

Herein, 1−H(z) is defined as Hₑ(Z).

In FIG. 4B, a clipping error is represented by an accumulated model, and can be represented using a discrete integrator H(z) having the transfer function shown in the following Equation 7. Here, H(z) is represented as a block 420 of FIG. 4B. In addition, a block 410 of FIG. 4B represents the clipping error model.

H(z)=(z⁻¹)/(1−z⁻¹)=1/(z−1) (7)

Here, in consideration of a difference D(z) between X(z) and Y(z) (refer to FIG. 4C), an equation [1+H(z)]Y(z)=H(z)X(z) +E(z) can be obtained from the following Equation 8.

$$D ( z ) = X ( z ) - Y ( z ) \\ \begin{matrix}Y ( z ) = H ( z ) D ( z ) + E ( z ) \\ = H ( z ) [ X ( z ) - Y ( z ) ] + E ( z ) \\ = H ( z ) X ( z ) - H ( z ) Y ( z ) + E ( z )\end{matrix} \\ [ 1 + H ( z ) ] Y ( z ) = H ( z ) X ( z ) + E ( z ) \qquad ( 8 )$$

Here, when it is assumed that Hₓ(z)=H(z)/(1+H(z)) and He(Z)=1/(1+H(z)), the following Equation 9 is obtained.

Hₓ(z)=H(z)/(1+H(z))=z⁻¹

Hₑ(z)=1/(I+H(z))=1−z⁻¹ (9)

Therefore, an equation Y(z)=Hₓ(z)X(z)+Hₑ(z)E(z) can be obtained from Equation 9.

Therefore, the quantization noise ε(n)=e(n)−e(n−1) or ε(z)=(1−z⁻¹)E(z), and a higher-order quantization noise transferring function Hₑ(Z)=(1−z⁻¹)^{p} can be obtained.

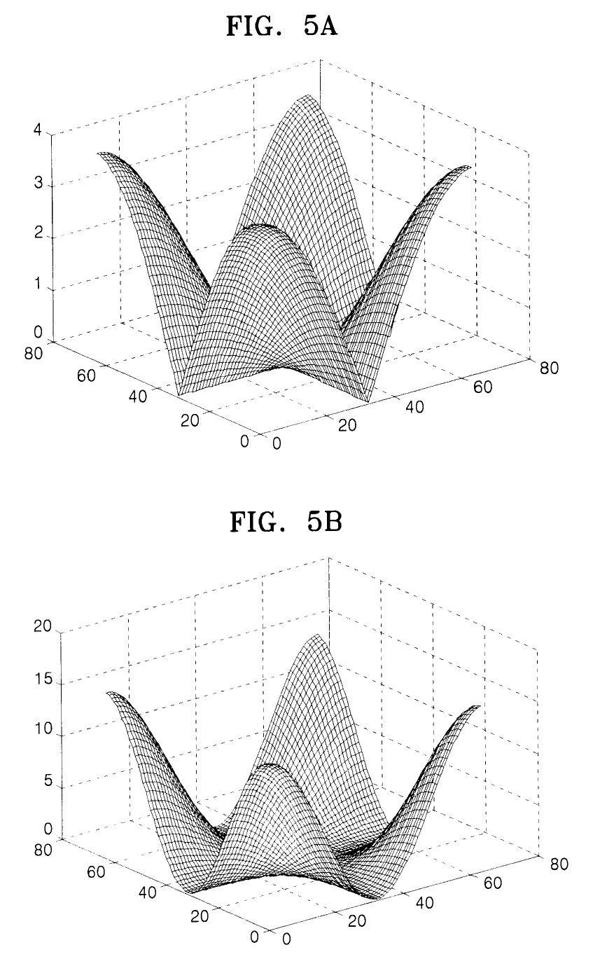

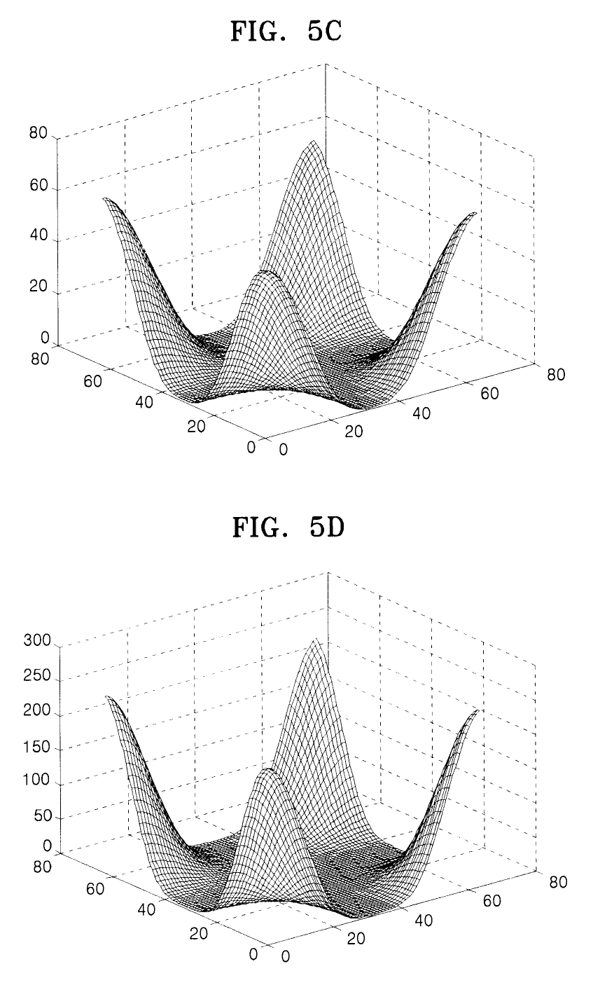

FIGS. 5A through 5D are graphs showing examples of quantizing noises calculated by the color compensation unit 150 of FIGS. 4A to 4C. In other words, FIG S. 5A through 5D show frequency characteristics of a first-order quantization noise error transferring function to a fourth-order quantization noise error transferring function. As shown in FIGS. 5A to 5D, when the number of orders p increases, the quantization noise moves to radio-frequency components.

The backlight brightness controller 170 generates a backlight brightness controlling signal for reducing the brightness of the backlight according to the IC output from the histogram analyzer 110. Electric current and voltage can be used to control the brightness of the backlight, and the voltage is commonly used to control the brightness of the backlight. However, a magnitude of the voltage applied to the backlight and the brightness of the backlight are not changed linearly. Therefore, the backlight brightness controlling signal corresponding to the reduction amount of the backlight brightness according to the received IC can be determined through experiment. In this case, a relation between the received IC and the output backlight brightness controlling signal can be stored in a look-up table. According to an exemplary embodiment of the present invention, when an electric current consumption is reduced by 30%, the power consumption can be reduced by 50%, by reducing the brightness of the backlight.

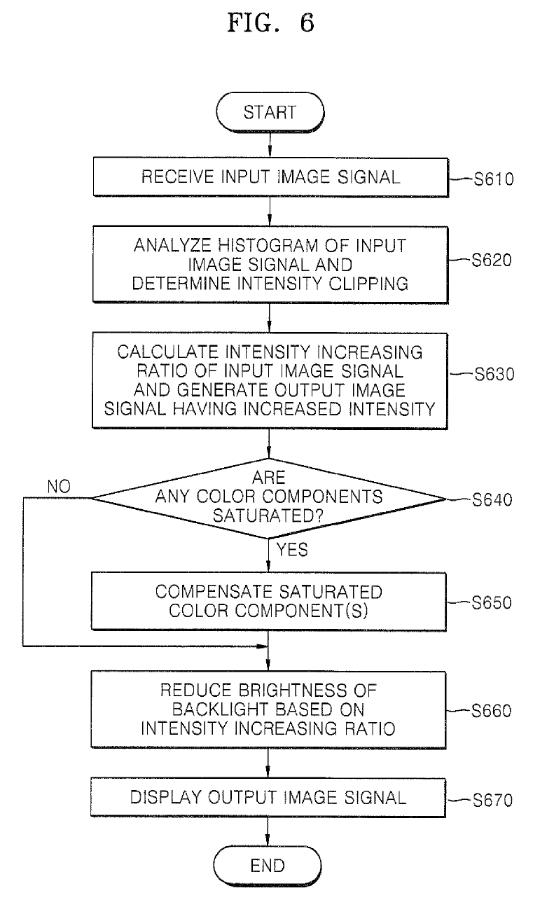

FIG. 6 is a flowchart illustrating a method of controlling a power consumption of a display device according to another exemplary embodiment of the present invention.

Referring to FIG. 6, when an input image signal is received (S610), a histogram of the input image signal is analyzed, and an IC is determined based on the analyzed histogram (S620). The IC can be determined based on the brightness distribution corresponding to an upper percentage of the input image signal, or by using the accumulated brightness error as described above.

When the IC is determined, an intensity increasing ratio of the input image signal is calculated. Then, the calculated intensity increasing ratio is multiplied with each of color components to generate an output image signal, the intensity of which is increased (S630). In this case, it is determined whether the color components are saturated (S640), and if the saturation occurs, the color components are compensated (S650). In order to compensate the color components, a new intensity increasing ratio can be calculated by applying a weighed value to the maximum and minimum gradation increasing rates, or the quantization noise can be modeled.

If the color components are not saturated, that is, if the saturation does not occur even when the gradation of the color components is increased due to the relatively low brightness of the input image signal, a brightness of a backlight is reduced based on the intensity increasing ratio (S660), and then the output image signal is displayed (S670). In order to reduce the brightness of the backlight, the look-up table that is prearranged can be used as described above.

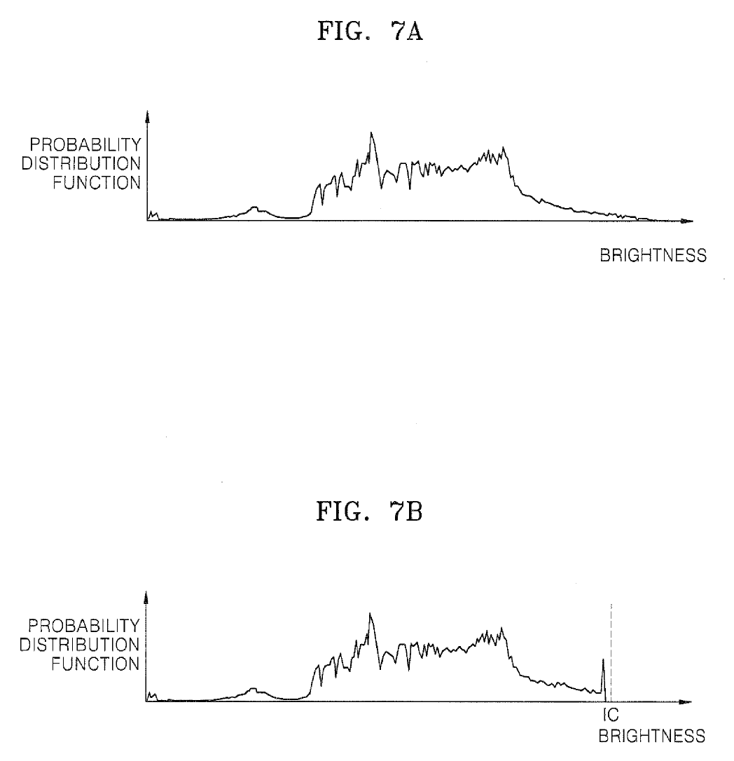

FIGS. 7A and 7B respectively illustrate brightness distribution of an input and output image signals according to an exemplary embodiment of the present invention. As shown in FIGS. 7A and 7B, since the brightness of the input image signal is increased and the brightness of the backlight is reduced, the histogram of the final output image signal is similar to that of the input image signal except that the brightness distribution of upper position of the IC is concentrated to lower position of the IC.

Specifically, FIGS. 7A and 7B are graphs showing the brightness distribution measured using an LCD television of 40 inches. As shown in FIG. 7A and 7B, the user hardly recognized any change to the brightness of the output image signal, however, the power consumption was reduced by 30% to 40% as a result of using the power controlling apparatus and method as described in the exemplary embodiments of the present invention.

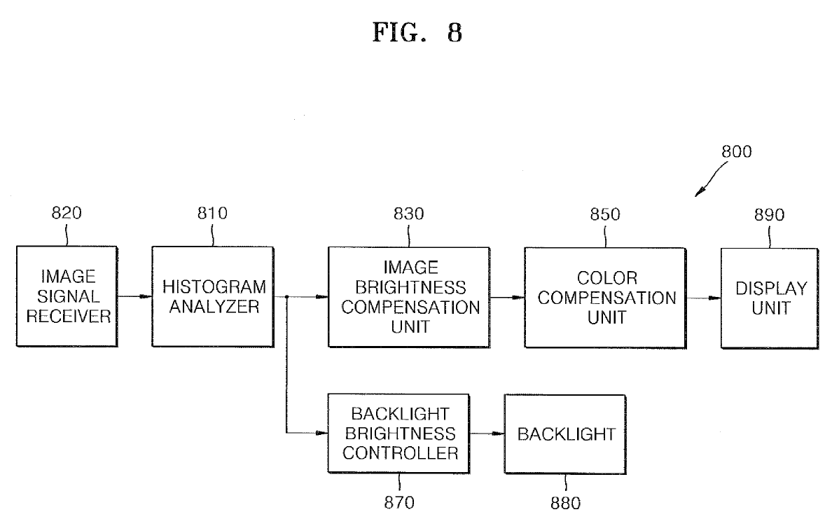

FIG. 8 is a block diagram showing a display device having a power consumption controlling function according to another exemplary embodiment of the present invention.

Referring to FIG. 8, an image signal receiver 820 receives an input image signal. Structures and operations of a histogram analyzer 810, an image brightness compensation unit 830, a color compensation unit 850, and a backlight brightness controller 870 of FIG. 8 are similar to those of the histogram analyzer 110, the image brightness compensation unit 130, the color compensation unit 150, and the backlight brightness controller 170 of FIG. 1. Therefore, descriptions for those are omitted.

An output image signal of the color compensation unit 850 is displayed on a display unit 890. The image signal displayed on the display unit 890 has the increased brightness. In addition, the backlight brightness controller 870 reduces the brightness of a backlight 880. In FIG. 8, the backlight 880 operates as a light source of the display device 800, but the present invention is not limited thereto. In addition, in FIG. 8, the display unit 890 is separated from the backlight 880, however, the display unit 890 and the backlight 880 can be integrated in the display device 800.

According to exemplary embodiments of the present invention, a brightness of an image signal is adaptively increased according to a histogram of an input image signal, and at the same time, a brightness of a backlight is reduced by an amount in proportion to the amount that the image signal brightness is increased. Therefore, power consumption of a display device can be reduced, while a user does not recognize any change in brightness.

In addition, according to the exemplary embodiments of the present invention, distortion of a color of an output image signal that can occur when the brightness of the input image signal is increased can be prevented.

In addition, according to the exemplary embodiments of the present invention, color components of the output image signal that will be saturated are compensated to minimize a degradation of the output image signal.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for controlling a power of a display device including a backlight, the apparatus comprising:
a histogram analyzer that analyzes a histogram of an input image signal including one or more color components, and determines an intensity clipping based on the analyzed histogram;
an image brightness compensation unit that calculates an intensity increasing ratio of the input image signal using the intensity clipping, and applies the intensity increasing ratio to each of the color components to generate an output image signal, an intensity of which is increased; and
a backlight brightness controller that controls a brightness of the backlight based on the intensity increasing ratio.

2. The apparatus of claim 1, further comprising:
a color compensation unit that detects saturated color components among the color components of the input image signal, and applies a color compensation ratio that is smaller than the intensity increasing ratio to the saturated color components to generate the output image signal.

3. The apparatus of claim 2, wherein the color compensation unit determines a maximum intensity increasing ratio and a minimum intensity increasing ratio of each of the saturated color components, and applies a color compensation weighed value to each of the maximum intensity increasing ratio and the minimum intensity increasing ratio to determine the color compensation ratio.

4. The apparatus of claim 2, wherein the color compensation unit calculates a quantization noise by modeling differences between the input image signal and the saturated color components, determines an error transfer function corresponding to the quantization noise, and applies the error transfer function to the input image signal to generate the output image signal.

5. The apparatus of claim 1, wherein the histogram analyzer sums probability distribution functions of the input image signal from a maximum gradation of the input image signal to a predetermined gradation, determines a gradation value where a summed result is greater than or equal to a predetermined value, and sets the gradation value as the intensity clipping.

6. The apparatus of claim 1, wherein the histogram analyzer multiplies a difference between a maximum gradation and a predetermined gradation with probability distribution functions of the input image signal from the maximum gradation to the predetermined gradation, determines a gradation value where a multiplied result is greater than or equal to a predetermined value, and sets the gradation value as the intensity clipping.

7. The apparatus of claim 1, wherein the image brightness compensation unit generates the output image signal using at least one intensity increasing ratio, and the intensity increasing ratio is reduced if the brightness of the input image signal increases.

8. The apparatus of claim 1, further comprising:
a look-up table that maps backlight brightness controlling values corresponding to the intensity clipping,
wherein the backlight brightness controller controls at least one of an electric current and a voltage applied to the backlight based on the backlight brightness controlling values.

9. A method of controlling a power of display device including a backlight, the method comprising:
analyzing a histogram of an input image signal including one or more color components, and determining an intensity clipping based on the analyzed histogram;
compensating an image brightness by calculating an intensity increasing ratio of the input image signal using the intensity clipping, and applying the intensity increasing ratio to each of the color components to generate an output image signal, an intensity of which is increased; and
controlling a brightness of the backlight based on the intensity increasing ratio.

10. The method of claim 9, further comprising:
compensating colors by detecting saturated color components among the color components of the input image signal, and applying a color compensation ratio that is smaller than the intensity increasing ratio to the saturated color components to generate the output image signal.

11. The method of claim 10, wherein the compensating the colors comprises:
determining a maximum intensity increasing ratio and a minimum intensity increasing ratio of each of the saturated color components; and
applying a color compensation weighed value to each of the maximum intensity increasing ratio and the minimum intensity increasing ratio to determine the color compensation ratio.

12. The method of claim 10, wherein the compensating the colors comprises:
calculating a quantization noise by modeling differences between the input image signal and the saturated color components;
determining an error transfer function corresponding to the quantization noise; and
applying the error transfer function to the input image signal to generate the output image signal.

13. The method of claim 9, wherein the analyzing the histogram of the input image signal comprises:
summing probability distribution functions of the input image signal from a maximum gradation of the input image signal to a predetermined gradation;
determining a gradation value where a summed result is greater than or equal to a predetermined value; and
setting the gradation value as the intensity clipping.

14. The method of claim 9, wherein the analyzing the histogram of the input image signal comprises:
multiplying a difference between a maximum gradation and a predetermined gradation with probability distribution functions of the input image signal from the maximum gradation to the predetermined gradation;
determining a gradation value where a multiplied result is greater than or equal to a predetermined value; and
setting the gradation value as the intensity clipping.

15. The method of claim 9, wherein the compensating the image brightness comprises:
generating the output image signal using at least one intensity increasing ratio,
wherein the intensity increasing ratio is reduced if the brightness of the input image signal increases.

16. The method of claim 9, wherein the controlling the brightness of the backlight comprises:
generating a look-up table that maps backlight brightness controlling values corresponding to the intensity clipping; and
controlling at least one of an electric current and a voltage applied to the backlight based on the backlight brightness controlling values.

17. The method of claim 9, wherein the controlling the brightness of the backlight comprises reducing the brightness of the backlight.

18. A display device including a backlight comprising:
an input image receiver that receives an input image signal including one or more color components;
a histogram analyzer that analyzes a histogram of the input image signal, and determines an intensity clipping based on the analyzed histogram;
an image brightness compensation unit that calculates an intensity increasing ratio of the input image signal using the intensity clipping, and applies the intensity increasing ratio to each of the color components to generate an output image signal, an intensity of which is increased;
a backlight brightness controller that controls a brightness of the backlight based on the intensity increasing ratio; and
a display unit that displays the output image signal.

19. The display device of claim 18, further comprising:
a color compensation unit that detects saturated color components among the color components of the input image signal, and applies a color compensation ratio that is smaller than the intensity increasing ratio to the saturated color components to generate the output image signal.

20. The display device of claim 19, wherein the color compensation unit determines a maximum intensity increasing ratio and a minimum intensity increasing ratio of each of the saturated color components, and applies a color compensation weighed value to each of the maximum intensity increasing ratio and the minimum intensity increasing ratio to determine the color compensation ratio.

21. The display device of claim 19, wherein the color compensation unit calculates a quantization noise by modeling differences between the input image signal and the saturated color components, determines an error transfer function corresponding to the quantization noise, and applies the error transfer function to the input image signal to generate the output image signal.

22. The display device of claim 18, wherein the histogram analyzer sums probability distribution functions of the input image signal from a maximum gradation of the input image signal to a predetermined gradation, determines a gradation value where a summed result is greater than or equal to a predetermined value, and sets the gradation value as the intensity clipping.

23. The display device of claim 18, wherein the histogram analyzer multiplies a difference between a maximum gradation and a predetermined gradation with probability distribution functions of the input image signal from the maximum gradation to the predetermined gradation, determines a gradation value where a multiplied result is greater than or equal to a predetermined value, and sets the gradation value as the intensity clipping.

24. The display device of claim 18, wherein the image brightness compensation unit generates the output image signal using at least one intensity increasing ratio, and the intensity increasing ratio is reduced if the brightness of the input image signal increases.

25. The display device of claim 18, further comprising:
a look-up table that maps backlight brightness controlling values corresponding to the intensity clipping,
wherein the backlight brightness controller controls at least one of an electric current and a voltage applied to the backlight based on the backlight brightness controlling values.
